(19) United States
(12) Patent Application Publication
(10) Pub. No.: US 2015/0326392 A1
(43) Pub. Date: Nov. 12, 2015

(54) MATRIX-BASED CRYPTOSYSTEM

(71) Applicant: Cavalry Storage, Inc., Ontario, CA (US)

(72) Inventors: Lipin Bill Cheng, Reynoldsburg, OH (US); RenJye Yeh, Chino Hills, CA (US)

(21) Appl. No.: 14/332,252

(22) Filed: Jul. 15, 2014

Related U.S. Application Data
(60) Provisional application No. 61/989,026, filed on May 6, 2014.

(51) Int. Cl. H04L 9/14; H04L 9/30; H04L 9/08

(52) U.S. Cl. CPC H04L 9/14; H04L 9/0861; H04L 9/30; H04L 2209/24

(57) ABSTRACT

Various embodiments herein describe methods for enhancing the Hill cipher by inserting a small amount of noise into the ciphertext. Encryption and decryption using this enhanced Hill cipher can be performed quickly. In particular, a pair of a public key matrix and a private key matrix can be derived from any text including, for example, user-specified text or codes, e.g., a user password. Keys can be generated quickly on-the-fly and therefore do not need to be stored on storage devices, e.g., hard drives. Communication between two computing devices can be secured by encrypting messages using the public key matrix and sending the encrypted data from a first computing device to a second computing device. The second computing device is able to decrypt the messages using at least the corresponding private key matrix.

### CROSS-REFERENCE TO RELATED APPLICATIONS

This application claims the benefit of U.S. Provisional Application No. 61/989,026, filed on May 6, 2014, entitled MATRIX-BASED PUBLIC KEY CRYPTOSYSTEM and which is hereby expressly incorporated herein by reference in its entirety.

### BACKGROUND

A substitution cipher is one type of encoding method that involves replacing plaintext with ciphertext. Replacing plaintext can involve replacing single letters, pairs of letters, triplets of letters, etc. An entity can decipher the ciphertext by performing an inverse substitution. One specific type of substitution cipher is the polygraphic substitution cipher. Polygraphic substitution ciphers operate by substituting plaintext letters in large groups instead of substituting individual letters.

The Hill cipher is a polygraphic substitution that can combine much larger groups of letters simultaneously using linear algebra. However, because it relies on linear algebra, the Hill cipher is vulnerable to a known-plaintext attack. That is, an unintended party is able to determine the encryption key that is used to create the ciphertext by sampling both the plaintext and the ciphertext created using the Hill cipher. Also the Hill cipher is not a public key scheme because its encryption and decryption practically use the same key.

### BRIEF DESCRIPTION OF THE DRAWINGS

Various embodiments in accordance with the present disclosure will be described with reference to the drawings, in which:

FIG. 1 illustrates an example of an environment for implementing aspects in accordance with various embodiments;

FIG. 2 illustrates another example of an environment for implementing aspects in accordance with various embodiments;

FIG. 3 illustrates an example process for generating asymmetric key matrices;

FIG. 4 illustrates an example process for encrypting data using a public key matrix; and

FIG. 5 is a schematic diagram of an example computing system.

### DETAILED DESCRIPTION

Systems and methods in accordance with various embodiments of the present disclosure overcome one or more of the above-referenced and other deficiencies in conventional approaches to encoding algorithms used in public key cryptography. In particular, various embodiments of the present disclosure can provide methods for enhancing the Hill cipher by inserting a small amount of noise into the ciphertext. Encryption and decryption using this enhanced Hill cipher can be performed quickly. In particular, key pairs can be derived from any text including, for example, user-specified text or codes, e.g., a user password. This feature simplifies key management, since private keys do not need to be stored on storage devices, e.g., hard drives.

The methods described herein also provide approaches for homomorphic encryption and secure multi-party communication. Other methods provide approaches for adapting the Hill cipher to produce digital signatures by hiding the signature key matrix with composite verification matrices and converted into a signature scheme, as described below.

Other advantages, variations, and functions are described and suggested below as may be provided in accordance with the various embodiments.

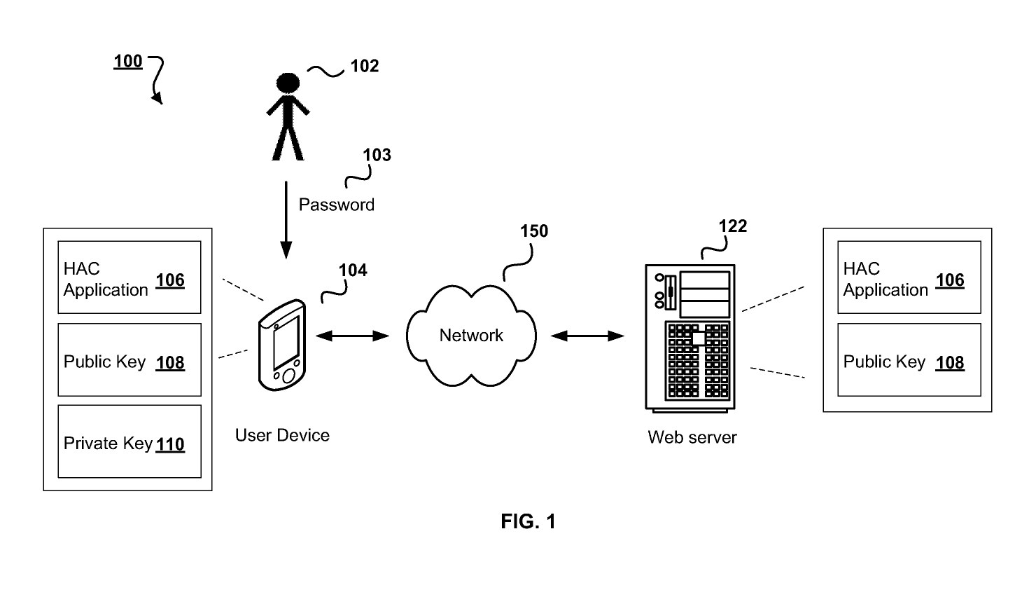

FIG. 1 illustrates an example of an environment 100 for implementing aspects in accordance with various embodiments. Although a computing device environment is described for purposes of explanation, different environments may be used, e.g., a web-based environment, to implement various embodiments. The environment 100 includes a user device 104 and a server 122.

The user device 104 generally includes memory, e.g., a random access memory (RAM), for storing instructions and data, and at least one processor for executing stored instructions. The user device 104 can include one or more components, e.g., software or hardware, that are configured to perform the operations described in this specification. Further, the user device 104 can be any appropriate device operable to send and receive requests, messages, or other types of information over the network 150. Some examples of user devices include personal computers, cellular phones, handheld messaging devices, laptop computers, personal data assistants, tablet devices, and the like.

The example environment 100 also includes a server 122, which can be implemented as computer programs on one or more computers in one or more locations, in which the systems, components, and techniques described below can be implemented. The server 122 generally includes memory, e.g., a random access memory (RAM), for storing instructions and data, and at least one processor for executing stored instructions. The server 122 can include one or more components, e.g., software or hardware, that are configured to perform the operations described in this specification. Further, the server 122 can be any appropriate device operable to send and receive requests, messages, or other types of information over the network 150.

The network 150 can include any appropriate network, including an intranet, the Internet, a cellular network, a local area network, a wide area network, or any other such network, or combination thereof. Components used for such a system can depend at least in part upon the type of network, the environment selected, or both. Protocols and components for communicating over such a network are well known and will not be discussed herein in detail. The user device 104 and the server 122 can communicate over the network 150 using wired or wireless connections, and combinations thereof.

The user device 104 and the server 122 can each include software, e.g., the Hill Asymmetric Cipher (HAC) application 106, that is configured to encrypt and decrypt data using the approaches described in this specification. For example, in FIG. 1, a user 102 operating the user device 104 is attempting to securely communicate information between the user device 104 and the server 122. The user 102 may use generally known public key infrastructure (PKI) to generate a public key and a private key that are both associated with the user 102. A public key infrastructure (PKI) is a system for the creation, storage, and distribution of digital certificates which are used to verify that a particular public key belongs to a certain entity. Typically, the PKI creates digital certificates which map public keys to entities or individuals. The PKI can securely store these certificates in a central repository and revokes them, if needed.

In various embodiments, the approaches described herein utilizing an enhanced Hill cipher allow the user 102 to generate asymmetric public 108 and private keys 110 based in part on user supplied text, e.g., the user's password. The enhanced Hill cipher is an extension of the existing Hill cipher. As mentioned, the encryption key of the existing Hill cipher is used in a linear scheme and thus needs to be kept a secret. However, using the approaches described herein, the Hill cipher can be extended to generate asymmetric keys that can be used as public and private keys.

In the example of FIG. 1, the user 102 interacts with the user device 104 to log into an account being hosted by the server 122. To ensure that communication between the user device 104 and the server 122 is kept private, the user device 104 can use the HAC application 106 to generate asymmetric key pairs 108 and 110 using the password 103 provided by the user 102.

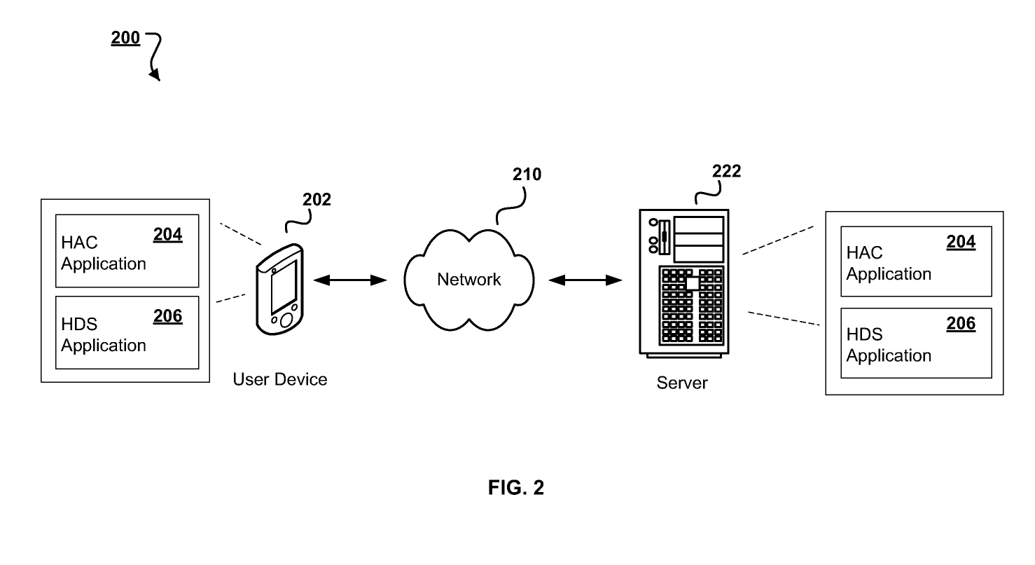

The HAC application 106 can use the password 103 as a seed to generate the key pairs, as described below. Thus, the key pairs 108 and 110 can be generated on-the-fly and need not be stored on storage devices, e.g., hard drives. In some embodiments, the keys 108 and 110 are each a matrix. For example, the public key 108 can be a quasi-random matrix that can be sent to the server 122 over the network 150. The server 122 can utilize the public key matrix 108 to encrypt communications being sent to the user device 104 using the approaches described below in reference to FIG. 2. Naturally, the user device 104 can decrypt communications encrypted with the public key matrix 108 using the complementary private key matrix 110.

As mentioned, the digitally certified public key matrix 108 can be stored on the server 122 to perform encryption of data being sent to the user device 104. Once the communication between the user device 104 and the server 122 has ended, for example, as a result of the user 102 logging out of her account hosted by the server 122, the private key matrix 110 can be removed from the user device 104. As a result, the risk of an unauthorized party stealing the user's private key 110 is reduced.

FIG. 2 illustrates an example of an environment 200 for implementing aspects in accordance with various embodiments. Although a computing device environment is described for purposes of explanation, different environments may be used, e.g., a web-based environment, to implement various embodiments. The environment 200 includes a user device 202 and a server 222.

The user device 202 generally includes memory, e.g., a random access memory (RAM), for storing instructions and data, and at least one processor for executing stored instructions. The user device 202 can include one or more components, e.g., software or hardware, that are configured to perform the operations described in this specification. Further, the user device 202 can be any appropriate device operable to send and receive requests, messages, or other types of information over the network 210. Some examples of user devices include personal computers, cellular phones, handheld messaging devices, laptop computers, personal data assistants, tablet devices, and the like.

The example environment 200 also includes a server 222, which can be implemented as computer programs on one or more computers in one or more locations, in which the systems, components, and techniques described below can be implemented. The server 222 generally includes memory, e.g., a random access memory (RAM), for storing instructions and data, and at least one processor for executing stored instructions. The server 222 can include one or more components, e.g., software or hardware, that are configured to perform the operations described in this specification. Further, the server 222 can be any appropriate device operable to send and receive requests, messages, or other types of information over the network 210.

The network 210 can include any appropriate network, including an intranet, the Internet, a cellular network, a local area network, a wide area network, or any other such network, or combination thereof. Components used for such a system can depend at least in part upon the type of network, the environment selected, or both. Protocols and components for communicating over such a network are well known and will not be discussed herein in detail. The user device 202 and the server 222 can communicate over the network 210 using wired or wireless connections, and combinations thereof.

The user device 202 and the server 222 can each include software, e.g., the Hill Asymmetric Cipher (HAC) application 204, that is configured to perform the operations described in this specification including, for example, asymmetrically performing encryption and decryption of information using the enhanced Hill cipher.

The HAC application 204 is configured to perform cryptographic operations using an enhanced Hill cipher that is an extension of the existing Hill cipher. As mentioned, the encryption key of the existing Hill cipher is used in a linear scheme and thus needs to be kept a secret.

In some embodiments, the HAC application 204 is configured to perform asymmetric encryption using the enhanced Hill cipher by inserting “noises” into the encryption to conceal the plain message being encrypted. To do so, the enhanced Hill cipher approach uses a pair of “symmetrically” generated matrices that allow for noise expansion and shrinking in the encrypted message.

Depending on the embodiment, the symmetrically generated matrices can be created using a fast matrix pair generator that creates a matrix (A2) as follows:

(I+Δ1)*(I+Δ2)*(I+Δ3)* . . .

where I is the identity matrix, Δ1 is a first random matrix, Δ2 is a second random matrix, Δ3 is a third random matrix. Each random matrix can have all zero integer values except for one non-diagonal element that is either 1 or −1. If the matrix dimension is 2-by-2, then (I+Δ) can be any of {0, 1, 1, 1}, {0, −1, 1, 1}, {0, 1, −1, 1}, {0, 1, 1, −1}, {1, 0, 1, 1}, {−1, 0, 1, 1}, {1, 0, −1, 1}, {1, 0, 1, −1}, {1, 1, 0, 1}, {−1, 1, 0, 1}, {1, −1, 0, 1}, {1, 1, 0, −1}, {1, 1, 1, 0}, {−1, 1, 1, 0}, {1, −1, 1, 0}, {1, 1, −1, 0}. All of the random numbers used in the matrix generation can be obtained from a pseudorandom generator using a seed, for example, a user-specified seed, e.g., a password.

To asymmetrically encrypt a message, the HAC application 204 generates a 2-by-2 (2×2) random invertible matrix A along with an inverse of the random invertible matrix A⁻¹. A is made of A=A1*A2, where A1 is random and A2 is an output of the generator described above, thus “symmetric”. The size of the matrix A2 is typically twice the size of the matrix A1, to compensate for A1, in addition to expanding/shrinking the noise in the encrypted message. For better security, the determinant of A1 includes a large strongly probable prime factor following, for example, the Rabin-Miller primality test. The random invertible matrix A can be generated using pseudorandom generator based on a user specified seed, e.g., a password, and, depending on the embodiment, may be of a different dimension, e.g., 3-by-3, 4-by-4, etc. A public key can be created using the matrix A, the inverted matrix A⁻¹, and randomly generated matrices. The randomly generated matrices can be provided by the user operating the user device 202.

One example approach for creating the public key P is:

P=P1, P2, P3, P4

where P1 is A*R1*A⁻¹, where P2 is A*R2*A⁻¹, where P3 is A*R3*A⁻¹, and where P4 is A*R4*A⁻¹.

Thus, the public key P is:

P=A*R1*A⁻¹,A*R2*A⁻¹,A*R3*A⁻¹,A*R4*A⁻¹

where P is the public key, A is the random invertible matrix, A⁻¹ is the inverted random invertible matrix A, and R1, R2, R3, and R4 are randomly generated matrices that are supplied by a user. That is, the matrices A, and R1, R2, R3, and R4 are generated using pseudorandom generators that uses a user-supplied password as the seed. Therefore, the user-supplied password is used to generate the same public and private keys. More generally, the public key P may be A*R1*B, A*R2*B . . . , wherein B is another random invertible matrix made of B2*B1. But P is “expandable” only if B=A⁻¹.

One example approach for creating a private key V for the public key P is:

V=V1 and V2

where V is the private key, V1 is A⁻¹, i.e., the inverted random invertible matrix A, and V2 is A, i.e., the random invertible matrix.

Thus, the private key V is:

V=A⁻¹ and A

To encrypt a message using the public key P, the message is broken up and inserted into a matrix of the same dimension as the public key P. For example, the message to be encoded may be “Hello”. Typically, inserting the message “Hello” into matrices involves breaking up the message into individual characters “H”, “e”, “l”, “l”, and “o” and inserting those characters in the matrices. The characters can be converted into binary integers using a character encoding scheme, e.g., Unicode, and these integers can then be inserted into the matrices in place of the actual characters themselves. For example, the letter “H” can be encoded as 72, “e” can be encoded as 101, “l” can be encoded as 105, and “o” can be encoded as 111. A matrix that includes the characters “H”, “e”, “l”, and “l” can therefore be represented as {72, 101, 105, 105}.

In this example, assuming that the public key P is a 2-by-2 dimension matrix, the message is an array {72, 101, 105, 105, 111}, representing “H”, “e”, “l”, “l”, and “o”. Appending a random array {233, 135, 13} to it and splitting into four parts would get {72+101*256, 105+105*256, 111+233*256, 135+13*256}={25928, 26985, 59759, 3463}, making up a 2-by-2 dimension matrix.

To encrypt the message M, the HAC application 204 generates an encrypted message E. One example approach for creating the encrypted message E is:

E=N*E1+E2

where E is the encrypted message, N is a scale factor of appropriate size for noise reduction, and E1 and E2 are encryption values, as described below.

For example, N can be determined as follows:

$$\begin{matrix}N = size of Y + 2 * size of R + 2 * size of determinant of A + \\ size of cushion \\ = ( \frac{2 * 16}{16} ) + 2 * 8 + 2 * 16 + 1 \\ = 51 bytes\end{matrix}$$

The encryption value E1 can be generated using the message M. One example approach for creating the encryption value E1 is:

E1=M*M

where E1 is the first encryption value and M is the matrix in which the original message was inserted.

The encryption value E2 can be generated based in part on expansions of the public key P, e.g., P1, P2, P3, P4, as described above, and random scalars of appropriate size to be used as noise to conceal E1. One example approach for creating the encryption value E2 is:

E2=Y1*P1*P1+Y2*P1*P2+Y3*P1*P3+Y4*P1*P4+Y5*P2*P1+Y6*P2*P2+Y7*P2*P3+Y8*P2*P4+Y9*P3*P1+Y10*P3*P2+Y11*P3*P3+Y12*P3*P4+Y13*P4*P1+Y14*P4*P2+Y15*P4*P3+Y16*P4*P4

where E2 is the second encryption value and Y1, Y2, Y3, Y4, Y5, Y6, Y7, Y8, Y9, Y10, Y11, Y12, Y13, Y14, Y15, and Y16 are random scalars of appropriate size to be used as noise to conceal E1.

A computing device, e.g., the user device 202, can multiply the private keys V1 and V2 with the encrypted message E to decrypt the encrypted message E. Thus, the encrypted message E can be decrypted, for example, by computing:

message=V1*E*V2

where message is the unencrypted message, V1 is A⁻¹, i.e., the inverted random invertible matrix A, V2 is A, i.e., the random invertible matrix, and E is the encrypted message.

For example, the message can be determined by computing V1*E*V2 as follows:

$$\begin{matrix}V 1 * E * V 2 = {A}^{- 1} * N * E 1 * A + {A}^{- 1} * E 2 * A \\ = {A}^{- 1} * N * E 1 * A + {A}^{- 1} * ( Y 1 * P 1 * P 1 + Y 2 * P 1 * P 2 + \\ Y 3 * P 1 * P 3 + Y 4 * P 1 * P 4 + Y 5 * P 2 * P 1 + Y 6 * P 2 * P 2 + \\ Y 7 * P 2 * P 3 + Y 8 * P 2 * P 4 + Y 9 * P 3 * P 1 + Y 10 * P 3 * P 2 + \\ Y 11 * P 3 * P 3 + Y 12 * P 3 * P 4 + Y 13 * P 4 * P 1 + \\ Y 14 * P 4 * P 2 + Y 15 * P 4 * P 3 + Y 16 * P 4 * P 4 ) * A \\ = {A}^{- 1} * N * E 1 * A + {A}^{- 1} * A * \\ ( Y 1 * R 1 * R 1 + Y 2 * R 1 * R 2 + \\ Y 3 * R 1 * R 3 + Y 4 * R 1 * R 4 + Y 5 * R 2 * R 1 + Y 6 * R 2 * R 2 + \\ Y 7 * R 2 * R 3 + Y 8 * R 2 * R 4 + Y 9 * R 3 * R 1 + Y 10 * R 3 * R 2 + \\ Y 11 * R 3 * R 3 + Y 12 * R 3 * R 4 + Y 13 * R 4 * R 1 + \\ Y 14 * R 4 * R 2 + Y 15 * R 4 * R 3 + Y 16 * R 4 * R 4 ) * {A}^{- 1} * A \\ = N * {A}^{- 1} * E 1 * A + \\ \begin{matrix} ( Y 1 * R 1 * R 1 + Y 2 * R 1 * R 2 + \\ Y 3 * R 1 * R 3 + Y 4 * R 1 * R 4 + Y 5 * R 2 * R 1 + Y 6 * R 2 * R 2 + \\ Y 7 * R 2 * R 3 + Y 8 * R 2 * R 4 + Y 9 * R 3 * R 1 + Y 10 * R 3 * R 2 + \\ Y 11 * R 3 * R 3 + Y 12 * R 3 * R 4 + Y 13 * R 4 * R 1 + \\ Y 14 * R 4 * R 2 + Y 15 * R 4 * R 3 + Y 16 * R 4 * R 4 )\end{matrix}\end{matrix}$$

Next, the computing device can solve for Z as follows:

$$\begin{matrix}Z = \frac{V 1 * E * V 2}{N} \\ = \frac{N * {A}^{- 1} * E 1 * A + ( Y 1 * R 1 * R 1 + Y 2 * R 1 * R 2 + … + Y 16 * R 4 * R 4 )}{N} \\ = {A}^{- 1} * E 1 * A\end{matrix}$$

where N and Y1, Y2, Y3, Y4, Y5, Y6, Y7, Y8, Y9, Y10, Y11, Y12, Y13, Y14, Y15, and Y16 were set up to eliminate Y1, Y2, Y3, Y4, Y5, Y6, Y7, Y8, Y9, Y10, Y11, Y12, Y13, Y14, Y15, and Y16 at this stage.

Next, the computing device can solve for S as follows:

S=V2*Z*V1=E1=M*M

The message can be decrypted by taking the square root of S as follows:

message=SQRT(S)

The square root of a 2-by-2 matrix can be explicitly solved. Those of bigger dimension matrices have to be solved with numerical methods, thus are much slower and impractical in general.

The security in the enhanced Hill cipher approach is based on inserting random scalars of appropriate size, i.e., Y1 . . . Y16, as random noises into the encrypted message E to hide the original message. In essence, decryption of the encrypted message E is a matter of reducing the uncertainties introduced by the Y values, e.g., Y1 . . . Y16, and amplified by the public key matrices, e.g., P1, P2, P3, and P4. The security against key cracking is in proportion to the minimum size of the component matrices in the public key.

In some embodiments, the encryption and decryption approach described above can also be performed in a manner in which homomorphism is preserved. When used properly, the use of homomorphism can be applied to security tools. To do so, the HAC application 204 can generate a 2-by-2 (2×2) random invertible matrix A along with an inverse of the random invertible matrix A⁻¹, as described above. A public key P and a private V is also determined, as described above.

To encrypt the message M, the HAC application 204 generates an encrypted message E. As described above, the encrypted message E can be determined as follows:

E=N*E1+E2

where E is the encrypted message, N is a scale factor of appropriate size for noise reduction, and E1 and E2 are encryption values, as described below.

For example, N can be determined as follows:

$$\begin{matrix}N = size of Y + 2 * size of R + 2 * size of determinant of A + \\ size of cushion + size of maximum message M \\ = ( \frac{2 * 16}{16} ) + 2 * 8 + 2 * 16 + 1 + 16 \\ = 67 bytes\end{matrix}$$

Random scalars X2, X3, and X4 can be generated similar to the random scalars Y1, Y2, . . . , and Y16.

The encryption value E1 can be generated using the random scalars X2, X3, and X4. One example approach for creating the encryption value E1 is:

E1=M*C1+X2*C2+X3*C3+X4*C4

where E1 is the first encryption value and M is the scalar representing the message, C1, C2, C3, and C4 are constant matrices, and X2, X3, and X4 are random scalars. Because E1 is linear with respect to M, the Hill cipher's additive and scalar multiplicative homomorphism is preserved.

The encryption value E2 can be generated based in part on expansions of the public key P, e.g., P1, P2, P3, P4, as described above, and random scalars of appropriate size to be used as noise to conceal E1. One example approach for creating the encryption value E2 is:

E2=Y1*P1*P1+Y2*P1*P2+Y3*P1*P3+Y4*P1*P4+Y5*P2*P1+Y6*P2*P2+Y7*P2*P3+Y8*P2*P4+Y9*P3*P1+Y10*P3*P2+Y11*P3*P3+Y12*P3*P4+Y13*P4*P1+Y14*P4*P2+Y15*P4*P3+Y16*P4*P4

where E2 is the second encryption value and Y1, Y2, Y3, Y4, Y5, Y6, Y7, Y8, Y9, Y10, Y11, Y12, Y13, Y14, Y15, and Y16 are random scalars of appropriate size to be used as noise to conceal E1.

A computing device, e.g., the user device 202, can multiply the private keys V1 and V2 with the encrypted message E to decrypt the encrypted message E. Thus, the encrypted message E can be decrypted, for example, by computing:

message=V1*E*V2

where message is the unencrypted message, V1 and V2 are private keys, and E is the encrypted message.

For example, the message can be determined by computing V1*E*V2 as follows:

$$\begin{matrix}V 1 * E * V 2 = {A}^{- 1} * N * E 1 * A + {A}^{- 1} * E 2 * A \\ = {A}^{- 1} * N * E 1 * A + {A}^{- 1} * ( Y 1 * P 1 * P 1 + Y 2 * P 1 * P 2 + \\ Y 3 * P 1 * P 3 + Y 4 * P 1 * P 4 + Y 5 * P 2 * P 1 + Y 6 * P 2 * P 2 + \\ Y 7 * P 2 * P 3 + Y 8 * P 2 * P 4 + Y 9 * P 3 * P 1 + Y 10 * P 3 * P 2 + \\ Y 11 * P 3 * P 3 + Y 12 * P 3 * P 4 + Y 13 * P 4 * P 1 + \\ Y 14 * P 4 * P 2 + Y 15 * P 4 * P 3 + Y 16 * P 4 * P 4 ) * A \\ = {A}^{- 1} * N * E 1 * A + {A}^{- 1} * A * \\ ( Y 1 * R 1 * R 1 + Y 2 * R 1 * R 2 + \\ Y 3 * R 1 * R 3 + Y 4 * R 1 * R 4 + Y 5 * R 2 * R 1 + Y 6 * R 2 * R 2 + \\ Y 7 * R 2 * R 3 + Y 8 * R 2 * R 4 + Y 9 * R 3 * R 1 + Y 10 * R 3 * R 2 + \\ Y 11 * R 3 * R 3 + Y 12 * R 3 * R 4 + Y 13 * R 4 * R 1 + \\ Y 14 * R 4 * R 2 + Y 15 * R 4 * R 3 + Y 16 * R 4 * R 4 ) * {A}^{- 1} * A \\ = N * {A}^{- 1} * E 1 * A + \\ \begin{matrix} ( Y 1 * R 1 * R 1 + Y 2 * R 1 * R 2 + \\ Y 3 * R 1 * R 3 + Y 4 * R 1 * R 4 + Y 5 * R 2 * R 1 + Y 6 * R 2 * R 2 + \\ Y 7 * R 2 * R 3 + Y 8 * R 2 * R 4 + Y 9 * R 3 * R 1 + Y 10 * R 3 * R 2 + \\ Y 11 * R 3 * R 3 + Y 12 * R 3 * R 4 + Y 13 * R 4 * R 1 + \\ Y 14 * R 4 * R 2 + Y 15 * R 4 * R 3 + Y 16 * R 4 * R 4 )\end{matrix}\end{matrix}$$

Next, the computing device can solve for Z as follows:

$$\begin{matrix}Z = \frac{V 1 * E * V 2}{N} \\ = \frac{N * {A}^{- 1} * E 1 * A + ( Y 1 * R 1 * R 1 + Y 2 * R 1 * R 2 + … + Y 16 * R 4 * R 4 )}{N} \\ = {A}^{- 1} * E 1 * A\end{matrix}$$

where N and Y1, Y2, Y3, Y4, Y5, Y6, Y7, Y8, Y9, Y10, Y11, Y12, Y13, Y14, Y15, and Y16 were set up to eliminate Y1, Y2, Y3, Y4, Y5, Y6, Y7, Y8, Y9, Y10, Y11, Y12, Y13, Y14, Y15, and Y16 at this stage.

Next, the computing device can solve for S as follows:

S=V2*Z*V1=E1

S=(M*C1+X2*C2+X3*C3+X4*C4)

At this point, S is reduced to four linear equations that are made out of the C-values, i.e., C1, C2, C3, and C4. The message can then be decrypted by solving the resulting linear equations.

As mentioned, the security in the enhanced Hill cipher approach is based on inserting random scalars of appropriate size, i.e., Y1 . . . Y16, as random noises into the encrypted message E to hide the original message. In essence, decryption of the encrypted message E is a matter of reducing the uncertainties introduced by the Y values, e.g., Y1 . . . Y16, and amplified by the public key matrices, e.g., P1, P2, P3, and P4.

The approaches, i.e., the enhanced Hill cipher, described above allow for extending the Hill cipher into an asymmetric scheme by inserting small noises into the encryption. Though small, this noise is enough to thwart unscrupulous decryption efforts of a message encrypted using the enhanced Hill cipher.

An example applying the approaches described above is as follows. A message is encoded, for example, by being transformed into Unicode. The message may be a symmetric encryption key or a piece of text, e.g., “Hello.” In some embodiments, random integers are appended to the message for added security. This random portion may represent up to half of the message size. Assuming an implementation that uses 2-by-2 matrices (2×2), the array representing the message (e.g., each character in the message can be included in the array, sequentially, as a separate entry) can then be split into four parts or four integers and inserted into the 2-by-2 matrix. An example of the 2-by-2 matrix including the four parts or integers is:

M={845, 576, −654, 278}

Negative signs may be arbitrarily inserted and are generally irrelevant for the approaches described herein.

As mentioned, the public key P can be created as follows:

P=P1, P2, P3, P4

where P1 is A*R1*A⁻¹, where P2 is A*R2*A⁻¹, where P3 is A*R3*A⁻¹, and where P4 is A*R4*A⁻¹. R1, R2, R3, and R4 are randomly generated matrices that are supplied by a user. As described above, all of these matrices are generated using the same user-supplied password.

In this example, R1={12, −45, −34, 51}, R2={23, 54, −19, −28}, R3={−35, 26, 29, −43}, and R4={−51, 34, 52, 37}.

Thus, the public key P is:

P=A*{12, −45, −34, 51}*A⁻¹, A*{23, 54, −19, −28}*A⁻¹, A*{−35, 26, 29, −43}*A⁻¹, A*{−51, 34, 52, 37}*A⁻¹

where P is the public key, A is the random invertible matrix, A⁻¹ is the inverted random matrix A, and where the determinant D of A is 63.

The expanded public key P′, E2, as described above, is as follows:

Y*P′=Y1*P1*P1+Y2*P1*P2+Y3*P1*P3+Y4*P1*P4+Y5*P2*P1+Y6*P2*P2+Y7*P2*P3+Y8*P2*P4+Y9*P3*P1+Y10*P3*P2+Y11*P3*P3+Y12*P3*P4+Y13*P4*P1+Y14*P4*P2+Y15*P4*P3+Y16*P4*P4

where Y1, Y2, Y3, Y4, Y5, Y6, Y7, Y8, Y9, Y10, Y11, Y12, Y13, Y14, Y15, and Y16 are random scalars of appropriate size.

In this example, Y1=3, Y2=8, Y3=−5, Y4=0, Y5=−4, Y6=9, Y7=7, Y8=−8, Y9=7, Y10=3, Y11=−2, Y12=6, Y13=3, Y14=−9, Y15=5, and Y16=−7. Further, the scale factor N=10*60*60*D*D*32=4,572,288,000.

To encrypt the message M, the HAC application 204 can compute:

$$N * E 1 = N * M * M = 4 , 572 , 288 , 000 * \{ 337321 , 646848 , - 734442 , - 299420 \}$$

$$E 2 = Y * {P}^{′} = 3 * A * \{ 12 , - 45 , - 34 , 51 \} * \{ 12 , - 45 , - 34 , 51 \} * {A}^{- 1} + 8 * A * \{ 12 , - 45 , - 34 , 51 \} * \{ 23 , 54 , - 19 , - 28 \} * {A}^{- 1} + ( - 5 ) * A * \{ 12 , - 45 , - 34 , 51 \} * \{ - 35 , 26 , 29 , - 43 \} * {A}^{- 1} + 0 * A * \{ 12 , - 45 , - 34 , 51 \} * \{ - 51 , 34 , 52 , 37 \} * {A}^{- 1} + ( - 4 ) * A * \{ 23 , 54 , - 19 , - 28 \} * \{ 12 , - 45 , - 34 , 51 \} * {A}^{- 1} + 9 * A * \{ 23 , 54 , - 19 , - 28 \} * \{ 23 , 54 , - 19 , - 28 \} * {A}^{- 1} + 7 * A * \{ 23 , 54 , - 19 , - 28 \} * \{ - 35 , 26 , 29 , - 43 \} * {A}^{- 1} + ( - 8 ) * A * \{ 23 , 54 , - 19 , - 28 \} * \{ - 51 , 34 , 52 , 37 \} * {A}^{- 1} + 7 * A * \{ - 35 , 26 , 29 , - 43 \} * \{ 12 , - 45 , - 34 , 51 \} * {A}^{- 1} + 3 * A * \{ - 35 , 26 , 29 , - 43 \} * \{ 23 , 54 , - 19 , - 28 \} * {A}^{- 1} + ( - 2 ) * A * \{ - 35 , 26 , 29 , - 43 \} * \{ - 35 , 26 , 29 , - 43 \} * {A}^{- 1} + 6 * A * \{ - 35 , 26 , 29 , - 43 \} * \{ - 51 , 34 , 52 , 37 \} * {A}^{- 1} + 3 * A * \{ - 51 , 34 , 52 , 37 \} * \{ 12 , - 45 , - 34 , 51 \} * {A}^{- 1} + ( - 9 ) * A * \{ - 51 , 34 , 52 , 37 \} * \{ 23 , 54 , - 19 , - 28 \} * {A}^{- 1} + 5 * A * \{ - 51 , 34 , 52 , 37 \} * \{ - 35 , 26 , 29 , - 43 \} * {A}^{- 1} + ( - 7 ) * A * \{ - 51 , 34 , 52 , 37 \} * \{ - 51 , 34 , 52 , 37 \} * {A}^{- 1}$$

The encrypted message E=N*E1+E2. The requirement here is that E2 is greater than N*E1, thereby implying that the matrix A in the public key P had to be chosen properly and the maximum message size is limited by the public key size.

To decrypt the encrypted message E, the HAC application 204 can compute:

$$X = {A}^{- 1} * E * A = {A}^{- 1} * N * E 1 * A + {A}^{- 1} * E 2 * A = {A}^{- 1} * 4 , 572 , 288 , 000 * \{ 337321 , 646848 , - 734442 , - 299420 \} * A + 3 * \{ 12 , - 45 , - 34 , 51 \} * \{ 12 , - 45 , - 34 , 51 \} * D * D + 8 * \{ 12 , - 45 , - 34 , 51 \} * \{ 23 , 54 , - 19 , - 28 \} * D * D + ( - 5 ) * \{ 12 , - 45 , - 34 , 51 \} * \{ - 35 , 26 , 29 , - 43 \} * D * D + 0 * \{ 12 , - 45 , - 34 , 51 \} * \{ - 51 , 34 , 52 , 37 \} * D * D + ( - 4 ) * \{ 23 , 54 , - 19 , - 28 \} * \{ 12 , - 45 , - 34 , 51 \} * D * D + 9 * \{ 23 , 54 , - 19 , - 28 \} * \{ 23 , 54 , - 19 , - 28 \} * D * D + 7 * \{ 23 , 54 , - 19 , - 28 \} * \{ - 35 , 26 , 29 , - 43 \} * D * D + ( - 8 ) * \{ 23 , 54 , - 19 , - 28 \} * \{ - 51 , 34 , 52 , 37 \} * D * D + 7 * \{ - 35 , 26 , 29 , - 43 \} * \{ 12 , - 45 , - 34 , 51 \} * D * D + 3 * \{ - 35 , 26 , 29 , - 43 \} * \{ 23 , 54 , - 19 , - 28 \} * D * D + ( - 2 ) * \{ - 35 , 26 , 29 , - 43 \} * \{ - 35 , 26 , 29 , - 43 \} * D * D + 6 * \{ - 35 , 26 , 29 , - 43 \} * \{ - 51 , 34 , 52 , 37 \} * D * D + 3 * \{ - 51 , 34 , 52 , 37 \} * \{ 12 , - 45 , - 34 , 51 \} * D * D + ( - 9 ) * \{ - 51 , 34 , 52 , 37 \} * \{ 23 , 54 , - 19 , - 28 \} * D * D + 5 * \{ - 51 , 34 , 52 , 37 \} * \{ - 35 , 26 , 29 , - 43 \} * D * D + ( - 7 ) * \{ - 51 , 34 , 52 , 37 \} * \{ - 51 , 34 , 52 , 37 \} * D * D$$

Next, the value Z is computed as follows:

$$\begin{matrix}Z = ( \frac{X}{N} ) \\ = ( \frac{X}{4 , 572 , 288 , 000} ) \\ = {A}^{- 1} * \{ 337321 , 646848 , - 734442 , - 299420 \} * A\end{matrix}$$

This computation is possible since the sum of all of the other components in X that make up the noise is less than 4,572,288,000. Thus, these components can be easily eliminated.

Next, the value S is computed as follows:

S=A*Z*A⁻¹=M*M={337321, 646848, −734442, −299420}

The square root of the value S produces the message M as follows:

\sqrt{S}=M={845, 576, −654, 278}

where any negative sign is ignored, and where random padding that was added is removed to restore the message to its original form. For example, if the random padding was {278}, then the original M would be {845, 576, 654}.

The approaches described herein can apply generally known techniques for salting, which can involve mixing up or enlarging information, e.g., user passwords. By applying salting techniques to user passwords, for example, short user passwords, the effectiveness of the approaches described herein, which can generate matrices based in part on user passwords, can be improved.

In some embodiments, the user device 202 and the server 222 can each include software, e.g., the Hill Digital Signature (HDS) application 206, that is configured to digitally sign information using a secret signature key. The signature key can be created by generating random matrices, e.g., 4-by-1 (4×1) random matrices, i.e., vectors, A1, A2, A3, and A4, using a user-specified pseudorandom generator.

A verification key V determined using the first row of the inverse of a 4-by-4 matrix that is constructed from the matrices A1, A2, A3, and A4. Thus, the verification key V is a composite 1-by-4 (1×4) matrix, i.e., vector, out of the A1, A2, A3, and A4 matrices. To generate the verification key V, construct a 4×4 matrix B using the matrices A1, A2, A3, and A4:
B=a11 a21 a31 a41
   a12 a22 a32 a42
   a13 a23 a33 a43
   a14 a24 a34 a44

where a11, a12, a13, and a14 correspond to the matrix A1, where a21, a22, a23, and a24 correspond to the matrix A2, where a31, a32, a33, and a34 correspond to the matrix A3, and where a41, a42, a43, and a44 correspond to the matrix A4.

Thus, in this example, the verification key V=1st row of the inverse of the matrix B, i.e., B⁻¹.

The signature key S=A1, A2, A3, and A4.

To sign data X which is no bigger than one A matrix element, random scalars Y2, Y3, and Y4 can be generated from X and from the signature key S. Y2, Y3, and Y4 can be generated using a pseudorandom generator based on X and S. That is, the same X and S will generate the same Y2, Y3, and Y4, and thus the same signature. This is in contrast to the encryption in HAC, wherein the random scalars Y1 . . . Y16 are “true” random numbers generated, for example, by the user device. Next, a value E that will be used with the verification key V to determine the authenticity of the signed data is computed. The value E can be a 4-by-1 matrix, i.e., vector. One example approach for computing E is:

E=X*A1+Y2*A2+Y3*A3+Y4*A4

The random scalars Y2, Y3, and Y4 are inserted to prevent plaintext attacks on the signature key. The computed value E can be used with the verification key V to verify the signed data X. One example approach for verifying the signed data X is:

X=V*E

In addition, the size of E is checked for validity. If the size of E is larger than expected, then it is an indication of a fake signature created without the use of the signature key, by means of, for example, the Euclidean algorithm, thus invalid. The maximum data size that can be signed is the size of one A matrix element. The random A matrices, depending on the embodiment, may be of a different dimension, e.g., 5 of 5-by-1, 6 of 6-by-1, etc. The security against signature faking is in proportion to the size difference between one V element and one E element, thus proportional to the size of one A element.

In some embodiments, the approaches described above may be complimented with Microsoft® Silverlight™ technology to perform various operations. Silverlight is an application framework for writing and running rich Internet applications. The run-time environment for Silverlight can be implemented as a web browser plug-in. For example, instead of relying on CAPTCHA (“Completely Automated Public Turing test to tell Computers and Humans Apart”) for preventing automated programs from creating new accounts, these approaches can be used to incorporate a secret code within the Silverlight™ plug-in which must be included in each new account registration request. By requiring that the secret code be included in the request for creating a new account, the new account creation process is made more difficult for an automated program to bypass the interactive web browser.

These approaches can also be implemented using Silverlight™ for anti-phishing efforts. For example, users can be required to verify a website before proceeding with a login. The verification can be included in a secret site seal that is associated with each login account. The secret site seal is encrypted with the public key owned by the user associated with the login account. Since only the authorized user will possess the private key, this ensures that only the authorized user will be able to see the seal. In some embodiments, the private key is automatically generated using the user's password as the seed to a pseudorandom generator. Thus, it is not necessary to store the user's private key on hardware. In instances where the user changes their password, a new public key can be generated and associated with the user's login account.

In some embodiments, these approaches can be implemented using Silverlight™ to further secure communication between computing devices to provide an experience that is similar to an HTTPS (HyperText Transfer Protocol Secure) secure login page. For example, only after the user site seal is verified, can the user's password that has been encrypted using the server's public key be sent from the user's computing device. Once the user's password is received by the server, the server can decrypt the encrypted password using the server's private key. Similarly, the server can encrypt user-bound data using the user's public key to ensure security in communications from the server to the user's computing device. The user's computing device can decrypt the user-bound data using the user's private key.

Additionally, Silverlight™ can be used to facilitate key management. For example, using Silverlight™, user public keys may be generated and stored with a server through which login accounts are created at the time the login accounts are created. Thus, the server is able to authenticate a public key owned by a particular login account that is with the server. The server may be able to serve as a certificate authority (CA) for validating a user corresponding to a login account, for example, by corroborating with a public notary to match a login account to an individual user.

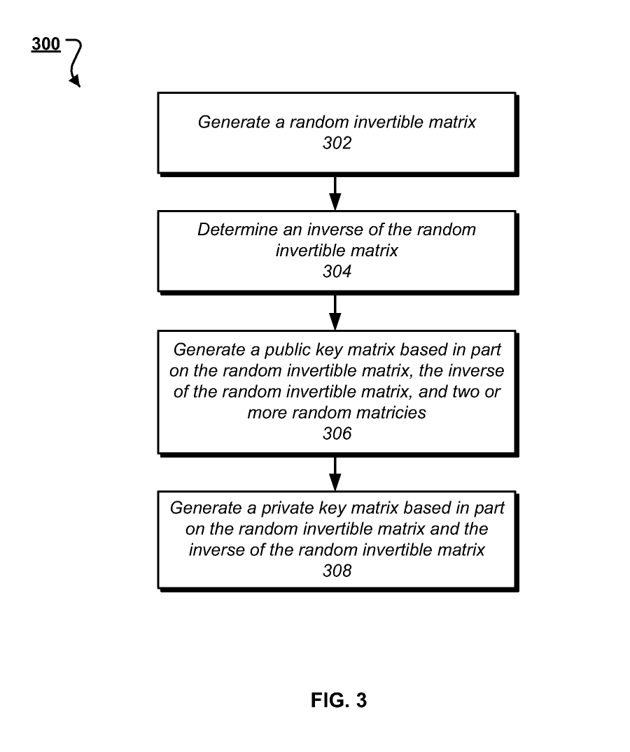

FIG. 3 illustrates an example process 300 for generating asymmetric key matrices. The example process 300 is provided merely as an example and additional or fewer steps may be performed in similar or alternative orders, or in parallel, within the scope of the various embodiments described in this specification.

A computing device generates a random invertible matrix 302. The computing device determines an inverse of the random invertible matrix 304. The computing device generates a public key matrix based in part on the random invertible matrix, the inverse of the random invertible matrix, and two or more randomly generated matrices, as described above 306. The computing device generates a private key matrix based in part on the random invertible matrix and the inverse of the random invertible matrix, as described above 308.

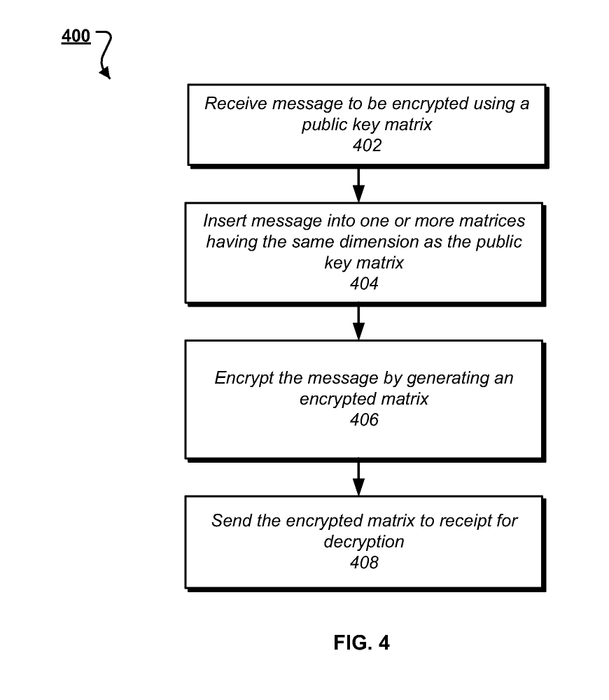

FIG. 4 illustrates an example process 400 for encrypting data using a public key matrix. The example process 400 is provided merely as an example and additional or fewer steps may be performed in similar or alternative orders, or in parallel, within the scope of the various embodiments described in this specification.

A computing device receives a message to be encrypted using a public key matrix 402. For example, the message may be received from an application, e.g., web browser, executing on the computing device and may be destined for a particular user. The public key matrix is a key that can be used to encrypt communications being sent to the particular user. The user can decrypt the encrypted communications using a complementary private key matrix. To encrypt the message, the computing device splits the message into portions and inserts the message into one matrix having that same dimension as the public key matrix 404. For example, if the public key matrix is a 2-by-2 matrix, then the message will be inserted into one matrix that has a 2-by-2 dimension.

The computing device encrypts the message by generating an encrypted matrix 406. The encrypted matrix can be generated based in part on the matrix into which the message was inserted, the public key matrix, and on two or more randomly selected scalars, as described above. Once the encrypted matrix has been determined, the computing device can send the encrypted matrix to a computing device of the particular user for decryption 408.

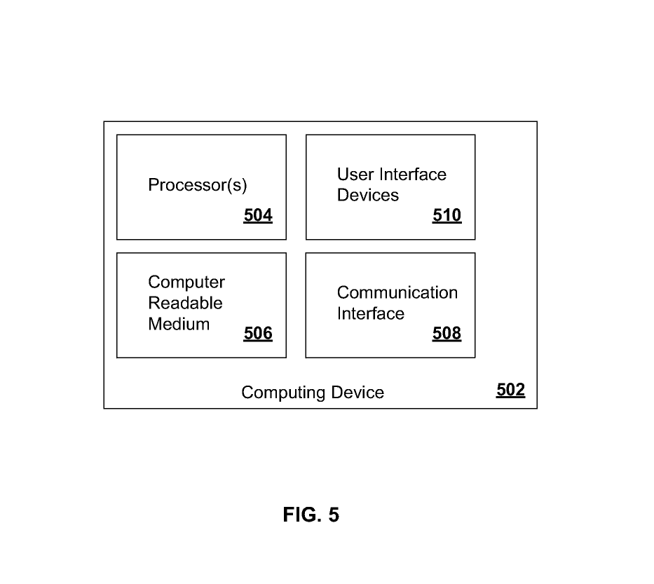

FIG. 5 is a schematic diagram of an example computing device 502. The computing device 502 includes hardware or firmware devices including one or more processors 504, a computer readable medium 506, a communication interface 508, and one or more user interface devices 510. Each processor 504 is capable of processing instructions for execution within the device 502. Each processor 504 is capable of processing instructions stored on the computer readable medium 506 or on a storage device. The device 502 uses its communication interface 508 to communicate with one or more other computing devices, for example, over the network.

Various embodiments of the subject matter described in this specification can be implemented in a computing system. The computing system may include a back-end component, e.g., a data server, a middleware component, e.g., an application server, or a front-end component, e.g., a client computer having a graphical user interface or a Web browser through which a user can interact with an implementation of the subject matter described in this specification. Naturally, any combination of one or more such back-end, middleware, or front-end components may be used. The components of the computing system can be connected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., a web page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method, the method comprising:
generating, using a computing device, a private key matrix based at least in part on a string of text provided by a user operating the computing device;
receiving, from at least one server, an encrypted message matrix, the encrypted message matrix having been encrypted using a public key matrix corresponding to the private key matrix, wherein the encrypted message matrix, the public key matrix, and the private key matrix each have a same dimension; and
decrypting the encrypted message matrix based at least in part on determining a product of the encrypted message matrix and the private key matrix.

2. The computer-implemented method of claim 1, wherein generating the private key matrix further comprises:
generating a quasi-random invertible matrix based at least in part on the string of text provided by the user, wherein the matrix is able to be incorporated into a public key; and
determining an inverse of the random invertible matrix.

3. The computer-implemented method of claim 2, further comprising:
generating the public key matrix corresponding to the private key matrix, wherein the public key matrix and the private key matrix each have the same dimension; and
sending the public key matrix to at least one server, wherein the server is configured to encrypt data being sent to the user operating the computing device using the public key matrix.

4. The computer-implemented method of claim 3, wherein generating the public key matrix further comprises:
determining products of the random invertible matrix, two or more randomly generated matrices, and the inverse of the random invertible matrix,
wherein the random invertible matrix, two or more randomly generated matrices, and the inverse of the random invertible matrix each have the same dimension.

5. The computer-implemented method of claim 1, further comprising:
sending, to the at least one server, at least one credential provided by the user to access a user account on the at least one server; and
obtaining access to the user account on the at least one server,
wherein the private key matrix is generated using the at least one credential.

6. The computer-implemented method of claim 5, further comprising:
determining that the user has logged out of the user account; and
removing data describing the private key matrix from the computing device.

7. The computer-implemented method of claim 1, wherein operations performed for generating the encrypted message matrix are either homomorphic or non-homomorphic.

8. A computer-implemented method, the method comprising:
obtaining, using at least one server, a message to be sent to a user operating a computing device;
inserting the message into a message matrix, the message matrix having a same dimension as a public key matrix associated with the user operating the computing device;
encrypting the message matrix using at least the public key matrix; and
sending the encrypted message matrix to the computing device.

9. The computer-implemented method of claim 8, wherein inserting the message into a message matrix further comprises:
inserting a respective numerical value for each character in the message into an array, wherein each character is inserted sequentially based at least in part on an order in which the character appears in the message;
inserting at least one random padding value into the array so that the count of values inserted in the array is divisible by the numerical value corresponding to the first dimension; and
generating the message matrix based at least in part on the array, wherein the message matrix has the same first dimension.

10. The computer-implemented method of claim 8, wherein encrypting the message matrix using at least the public key matrix further comprises:
determining at least a product of the message matrix with itself, the public key matrix, and two or more randomly generated scalars.

11. The computer-implemented method of claim 8, wherein encrypting the message matrix using at least the public key matrix further comprises:
generating a first encryption value by determining a product of the message matrix with itself;
generating a second encryption value based at least in part on two or more expansions of the public key matrix and two or more random scalars, wherein a size of each scalar is selected to conceal the first encryption value; and
determining (i) a product of the first encryption value with a scale factor of appropriate size for noise reduction and (ii) the sum of the product and the second encryption value.

12. The computer-implemented method of claim 8, wherein the computing device is able to decrypt the encrypted message matrix based at least in part on a corresponding private key matrix, the private key matrix having the same first dimension.

13. The computer-implemented method of claim 8, wherein the private key matrix is determined based at least in part a random invertible matrix and an inverse of the random invertible matrix, and wherein the random invertible matrix is generated based at least in part on a string of text provided by the user.

14. The computer-implemented method of claim 8, further comprising:
receiving, from the computing device, at least one credential provided by the user to access a user account on the at least one server, wherein the at least one credential includes the public key matrix associated with the user; and
providing, to the user operating the computing device, access to the user account.

15. A system, comprising:
at least one processor; and
memory storing instructions for digitally signing data that, when executed by the at least one processor, cause the system to:
generate a verification key based at least in part on a matrix of a particular dimension, wherein the matrix is constructed using a plurality of randomly generated vectors that are combined to correspond to the particular dimension, wherein each of the plurality of randomly generated vectors are included in a signature key; and
determining a signature for a data object based at least in part on products of the data object and a plurality of randomly generated scalars, with the signature key, the scalars being determined using at least the data object and the signature key.

16. The system of claim 15, wherein generating the verification key further comprises:
determining an inverse of the matrix; and
selecting a first row of the inverted matrix as the verification key.

17. The system of claim 15, wherein the matrix has a 4-by-4 dimension, wherein the plurality of randomly generated vectors includes a first vector, a second vector, a third vector, and a fourth vector, each of the first vector, the second vector, the third vector, and the fourth vector having a 4-by-1 dimension, wherein the verification key has a 1-by-4 dimension, and wherein the signature has a 4-by-1 dimension.

18. The system of claim 15, wherein the instructions further comprise:
determining a product of the verification key and the signature for the data object; and
verifying an authenticity of the data object by determining that the data object matches the product of the verification key and the signature for the data object, and that the size of the signature is valid.
